(19) United States
(12) Patent Application Publication
(10) Pub. No.: US 2009/0295835 A1
(43) Pub. Date: Dec. 3, 2009

(54) METHOD FOR DISPLAYING AN IMAGE ON A DISPLAY

(75) Inventor: Per Ove HUSOY, Lysaker (NO)

Correspondence Address: OBLON, SPIVAK, MCCLELLAND MAIER & NEUSTADT, L.L.P., 1940 DUKE STREET, ALEXANDRIA, VA, 22314, US

(73) Assignee: TANDBERG TELECOM AS, Lysaker (NO)

(21) Appl. No.: 12/473,929

(22) Filed: May 28, 2009

Related U.S. Application Data
(60) Provisional application No. 61/129,009, filed on May 30, 2008.

(30) Foreign Application Priority Data
May 30, 2008 (NO) 20082451

(51) Int. Cl. G09G 5/00

(52) U.S. Cl. 345/660

(57) ABSTRACT

A method for displaying an image on a display of a video conferencing apparatus, including: providing, at the display of the video conferencing apparatus, a primary image; providing, at the video conferencing apparatus, an observation angle of a viewer with respect to the display; modifying, at the video conferencing apparatus, the primary image by applying a scaling factor that is a function of the observation angle to the primary image, resulting in a modified image; and displaying the modified image on the display and the primary image on the display, wherein the modified image and the primary image are displayed in different viewing directions on a same display area of the display.

### CROSS-REFERENCE TO RELATED APPLICATIONS

The present application claims the benefit of the filing date of provisional application 61/129,009, filed May 30, 2008, the entire contents of which are hereby incorporated by reference. The present application claims priority to Norwegian application NO020082451, filed May 30, 2008 in the Norwegian Patent Office, the entire contents of which are hereby incorporated by reference.

### TECHNICAL FIELD

Exemplary embodiments described herein relate to modifying and displaying an image on a display, in particular in the field of video conferencing and telepresence systems.

### BACKGROUND

Conventional videoconferencing systems comprise a number of end-points communicating real-time video, audio and/or data (often referred to as duo video) streams over and between various networks such as WAN, LAN and circuit switched networks.

A number of videoconference systems residing at different sites may participate in the same conference, most often, through one or more MCU's (Multipoint Control Unit) performing i.e. switching and mixing functions to allow the audiovisual terminals to intercommunicate properly.

Video conferencing systems presently provide communication between at least two locations for allowing a video conference among participants situated at each station. Conventionally, the video conferencing arrangements are provided with one or more cameras. The outputs of those cameras are transmitted along with audio signals to a corresponding plurality of displays at a second location such that the participants at the first location are perceived to be present or face-to-face with participants at the second location.

Telepresence systems are enhanced video conference systems with a number of large scaled displays for life-sized video, often installed in rooms with interior dedicated and tailored for video conferencing, all to create a conference as close to personal meetings as possible.

FIG. 1 is a schematic view illustrating conventional aspects of telepresence videoconferencing.

A display device 160 of a videoconferencing device, in particular a videoconferencing endpoint of the telepresence type, is arranged in front of a plurality of (four illustrated) local conference participants. The local participants are located along a table, facing the display device 160 which includes a plurality of display screens. In the illustrated example, four display screens are included in the display device 160. A first 100, a second 110 and a third 120 display screens are arranged adjacent to each other. The first 100, second 110 and third 120 display screens are used for displaying images captured at one or more remote conference sites. A fourth display screen is arranged at a central position below the second display screen 110. In a typical use, the fourth screen may be used for computer-generated presentations or other secondary conference information. Video cameras such as the video camera 130 are arranged on top of the display screens in order to capture images of the local participants, which are transmitted to corresponding remote video conference sites.

A purpose of the setup shown in FIG. 1 is to give the local participants a feeling of actually being present in the same meeting-room as the remote participants that are shown on the respective display screens 100, 110, 120.

Key factors in achieving a feeling of presence are the ability to see at whom the remote participants are looking, that all the participants are displayed in real life size and that all displayed participants appear equally sized relative to each other. Another provision for achieving high quality telepresence is that the images of the remote participants are presented to each local participant as undistorted as possible.

In a typical telepresence setup such as the one shown in FIG. 1, the width of the display device 160 may be approximately 3 meters or more. The distance between the local participants and the opposing display units may typically be in the order of approximately 2 meters. This means that when the leftmost 150 local participant is looking at a participant on the rightmost, third display screen 120, his or her observation angle α (angle of view with respect to a direction perpendicular to the display screen 120) will become quite large.

A complete two dimensional rendering of a three dimensional object can at best be observed with correct proportions from one specific viewing angle. For a normal TV or videoconference display unit, this viewing angle is traditionally designed to be 0°, or directly in front of and centered on the screen. For observers located at angles more than 0° from a line perpendicular to the screen, images will appear distorted, with objects looking taller and thinner/more narrow than they actually are.

Consequently, there is a need for removing or reducing the geometric distortion caused by the observation angle between a viewer and a display screen.

Conventionally, such geometric distortion has been reduced by arranging the display screens so as to form an angled wall in front of the local participants. Also, the local participants are arranged in an angled way, mirroring the angled wall of the display screen. An example of such an arrangement has been shown in US-2007/0263080.

Such conventional solutions have the disadvantage that the conferencing system occupies a significant space in the conference room. Since most conference rooms have a rectangular base, it would be advantageous and effective to utilize the available space by arranging the display screens in a straight manner parallel to or along a wall. Also, it would be advantageous to arrange the line of local participants in a straight line parallel to the arrangement of display screens.

### SUMMARY

A method for displaying an image on a display of a video conferencing apparatus, including: providing, at the display of the video conferencing apparatus, a primary image; providing, at the video conferencing apparatus, an observation angle of a viewer with respect to the display; modifying, at the video conferencing apparatus, the primary image by applying a scaling factor that is a function of the observation angle to the primary image, resulting in a modified image; and displaying the modified image on the display and the primary image on the display, wherein the modified image and the primary image are displayed in different viewing directions on a same display area of the display.

### BRIEF DESCRIPTION OF THE DRAWINGS

In order to make the invention more readily understandable, the discussion that follows will refer to the accompanying drawings, wherein

FIG. 1 is a schematic view illustrating conventional aspects of telepresence videoconferencing,

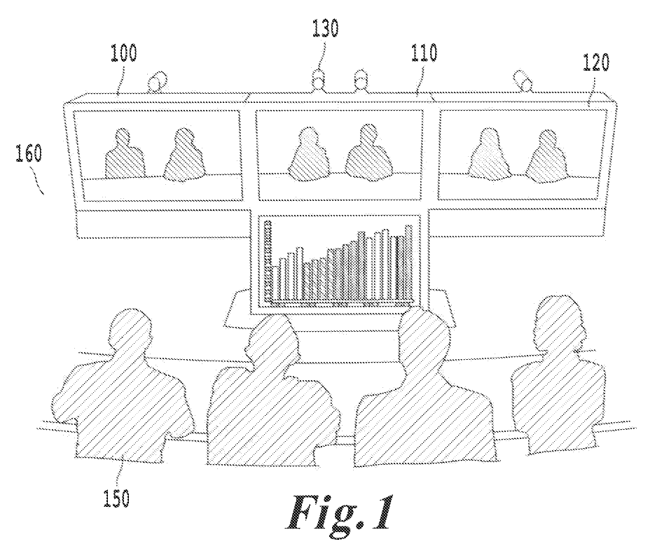

FIG. 2 is a schematic flow chart illustrating the principles of a method for displaying an image on a display,

FIG. 3 is a schematic block diagram illustrating the principles of a video conferencing device,

FIG. 4 is a schematic block diagram illustrating principles of a telepresence videoconference, and

FIG. 5 illustrates a computer system upon which an embodiment of the present invention may be implemented.

### DETAILED DESCRIPTION OF EMBODIMENTS

In the following, exemplary embodiments will be discussed by referring to the accompanying drawings. However, people skilled in the art will realize other applications and modifications within the scope of the invention as defined in the enclosed claims.

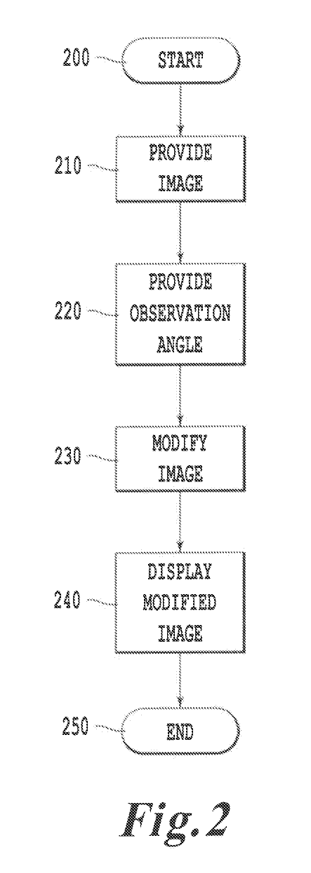

FIG. 2 is a schematic flow chart illustrating the principles of a method for displaying an image on a display.

The method starts at the initiating step 200.

A primary image is provided in the image providing step 210. This step may e.g. include reading a video signal which originates from a remote conference site, from appropriate circuitry such as a codec included in a video conference endpoint.

Next, in the observation angle providing step 220, an observation angle of a viewer with respect to the display is provided.

In one aspect, the observation angle is provided as a predetermined angle value, e.g. it may be read from a memory, register, a file or another suitable storage space.

In another aspect, the observation angle is provided by determining the value of an angle between a viewer direction, i.e. the direction between the viewer's position and a point of the display, and a display direction, i.e. the direction perpendicular to the display, specifically the front of the display.

In an aspect, the observation angle may be determined by analyzing an image captured by a camera, e.g. a video camera, arranged e.g. on top of the display. The camera may be a camera that is also used for videoconferencing purposes in a videoconferencing arrangement. In such a case the angle may be determined e.g. by detecting if a viewer is present in one or more predetermined horizontal portions of the camera image, and setting approximate values for the observation angle accordingly. In another example, one or more sensors (e.g. optical sensors) may be suitably arranged to determine if a viewer is present in an area corresponding to an observation angle or a range of observation angles, and if a viewer is determined to be present, the observation angle is set accordingly.

In the present context the value of the observation angle should be considered as positive or zero. More specifically, for practical purposes the angle will always be between 0 and 90 degrees.

The display may have a flat or substantially flat front surface, and the front surface of the display may be vertical or substantially vertical. However, the display may alternatively be arranged differently, e.g. tilted downwards or upwards, still in accordance with the principles of the invention.

The viewer direction may be the direction between the viewer's position and a central point of the display, such as the midpoint of the display. Alternatively, the viewer direction may be the direction between the viewer's position and another point within the display area.

The viewer's position may be understood to be the viewing position of the viewer, i.e. the position or the approximate position of the viewer's eyes.

In an aspect, the observation angle is in a horizontal plane. If the viewer direction and/or the display direction are not horizontal, their projections onto a horizontal plane may be used for determining an approximation to the observation angle in a horizontal plane, and this approximation may be used as the observation angle.

Next, in the image modifying step 230, the primary image is modified as a function of the observation angle. This results in a modified image.

In an aspect, in particular applicable when the observation angle is in a horizontal plane, the modifying step comprises a horizontal scaling of the primary image.

More specifically, the horizontal scaling may comprise horizontally extending the primary image, using an extension factor. The extension factor should be larger for higher observation angles than for smaller observation angles.

In a particular embodiment, the extension factor is substantially in inverse proportion to a cosine function of the observation angle. More specifically, the extension factor may be inverse proportional to the cosine function of the observation angle. Even more specifically, the extension factor may be the cosine function of the observation angle.

As an alternative to the horizontal scaling, in particular when the observation angle is substantially non-horizontal, a scaling in another direction, such as vertical, diagonal or slanting scaling, could be performed as part of the image modifying step 230.

The modifying step may additionally include cutting, removing or ignoring remaining side areas of the image.

In the image modifying step 230 the primary image is transformed into the modified image in such a way as to compensate for distortion caused by the viewer's actual position, which diverges from a position right in front of the display.

Next, in the displaying step 240, the modified image is displayed on the display.

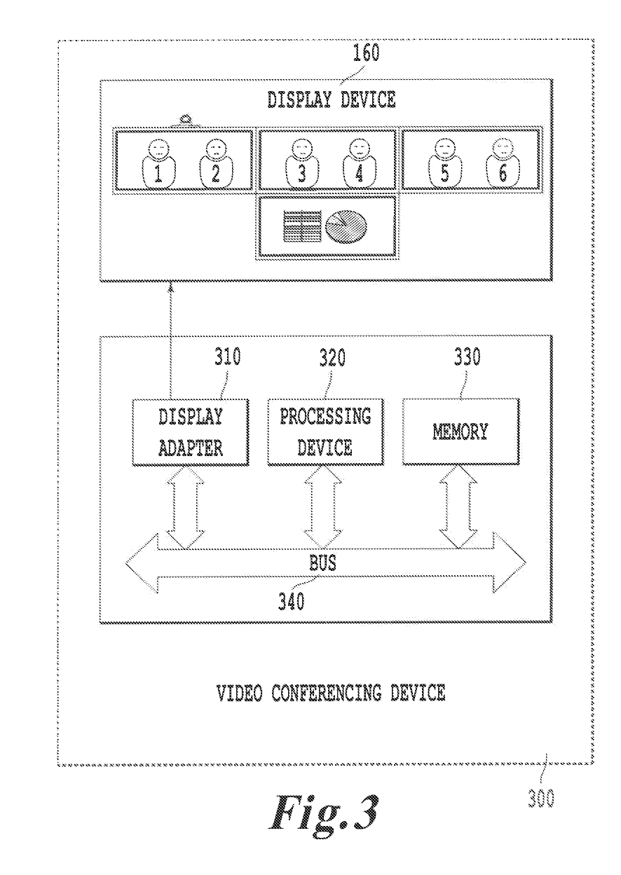

In a particular embodiment, the display is of a type which is arranged for displaying a plurality of different images in different viewing directions. Such a display may either be an integrated multi-view display or a multi-view projection screen which is illuminated by a plurality of projectors. Both the above classes of displays, in the following called “multi-view displays”, will be described in closer detail with reference to FIG. 3 below.

In a further aspect, when a multi-view display is used, the modified image is displayed in one of the plurality of available viewing directions. Also, the primary image, i.e. the unmodified image, may be displayed in another of the plurality of viewing directions.

In an aspect, the multi-view display provides two viewing directions.

In another aspect, the multi-view display provides three viewing directions, and the multi-view display is enabled to display different images, represented by separate input signals, in the three directions.

In still another aspect, the multi-view display may provide four or more viewing directions.

In any one of the above aspects the viewing directions may include a primary viewing direction, corresponding to a small (or zero) observation angle, and a secondary viewing direction, corresponding to an observation angle substantially different from zero.

The small observation angle may e.g. be less than 45 degrees, or less than 30 degrees, or less than 20 degrees.

The observation angle which is substantially different from zero may e.g. be between 45 and 90 degrees, or between 55 and 75 degrees.

In the above detailed description, an “image” has been used as a general expression for the content to be displayed on the display. It should be understood that both the primary image and the modified image may be included in video signals. This means that the term “image”, as used in the present specification, should be understood as covering both still images and moving images/video images, and that the image is usually represented by an electronic signal, which may be a digital or an analog signal, or a composition/combination of more than one signal.

The signal representing the image may be a video signal received from a remote video conference device, transferred via at least one communication network and possibly at least one Multipoint Control Units.

The method as described in the present detailed description may be performed by a processing device included in a video conferencing device.

More specifically, the method may be implemented as a set of processing instructions or computer program instructions, which may be tangibly stored in a medium or a memory (i.e., a computer readable storage medium). Alternatively, the method may be implemented as a set of processing instruction or computer program instructions encoded in a propagated signal. The set of processing instructions is configured so as to cause an appropriate device, in particular a video conferencing device, to perform the described method when the instructions are executed by a processing device included in the device.

FIG. 3 is a schematic block diagram illustrating a video conferencing device 300, in particular a telepresence video conference endpoint, which is configured to operate in accordance with the method described above. An example of a telepresence video conference endpoint is the TANDBERG Experia™ telepresence system. Telepresence systems are also described in U.S. patent application Ser. No. 12/050,004 (filed Mar. 17, 2008) and U.S. Patent Application Ser. No. 60/983,459 (filed Oct. 29, 2007), the contents of both of which are hereby incorporated by reference in their entirety.

The video conferencing device 300 comprises a processing device 320, a memory 330, a display adapter 310, all interconnected via an internal bus 340, and a display device 160. The display device may include a set of display screens, such as three adjacent display screens.

The illustrated elements of the video conferencing device 300 are shown for the purpose of explaining principles of the invention. Thus, it will be understood that additional elements may be included in an actual implementation of a video conferencing device.

At least one of the display screens may be a multi-view display screen. In an aspect, the two outermost display screens (the left display screen and the right display screen) may be multi-view display screens. In another aspect, all the three adjacent displays are multi-view display screens.

A fourth display screen has been illustrated as being arranged below the middle display screen in the display device 160. The fourth display screen may be a regular display screen or a multi-view display screen.

The memory 330 comprises processing instructions which enable the video conferencing device to perform appropriate, regular video conferencing functions and operations.

Additionally, the memory 330 comprises a set of processing instructions as described above with reference to the method illustrated in FIG. 2, resulting in that the processing device 320 causes the video conferencing device 300 to perform the presently disclosed method for displaying an image when the processing instructions are executed by the processing device 320.

In the case of a multi-view display, the display may either be an integrated multi-view display or a multi-view projection screen which is illuminated by a plurality of projectors. Other types of multi-view displays may also be appropriately used, provided that the display is enabled for displaying two or more different images in different viewing directions.

An integrated multi-view display may e.g. be an LCD screen using any of a number of proprietary technologies, such as a parallax barrier superimposed on an ordinary TFT LCD. The LCD sends the light from the backlight into right and left directions, making it possible to show different information and visual content on the same screen at the same time depending on the viewing angle. Controlling the viewing angle in this way allows the information or visual content to be tailored to multiple users viewing the same screen. This kind of LCDs are commercially available, and are conventionally used for e.g. in vehicles, for showing a map on the driver side, while the passenger side shows a movie on DVD or as an advertisement monitor, where a passerby who comes from right direction can see one advertisement, and a passerby who comes from left direction can see another advertisement.

Examples of integrated multi-view display technology that may be useful for implementing certain parts of embodiments of the present invention have been described in US-2007/0035565, U.S. Pat. No. 6,954,185, and US-2008/0001847, the contents of each of which is hereby incorporated by reference in its entirety.

A multi-view projection screen which is illuminated by a plurality of projectors has been described in, e.g., US-2006/0109548, which is incorporated by reference in its entirety. A plurality of images are projected onto a special reflection screen, from different directions, and the images are capable of being separately viewed in a plurality of viewing regions.

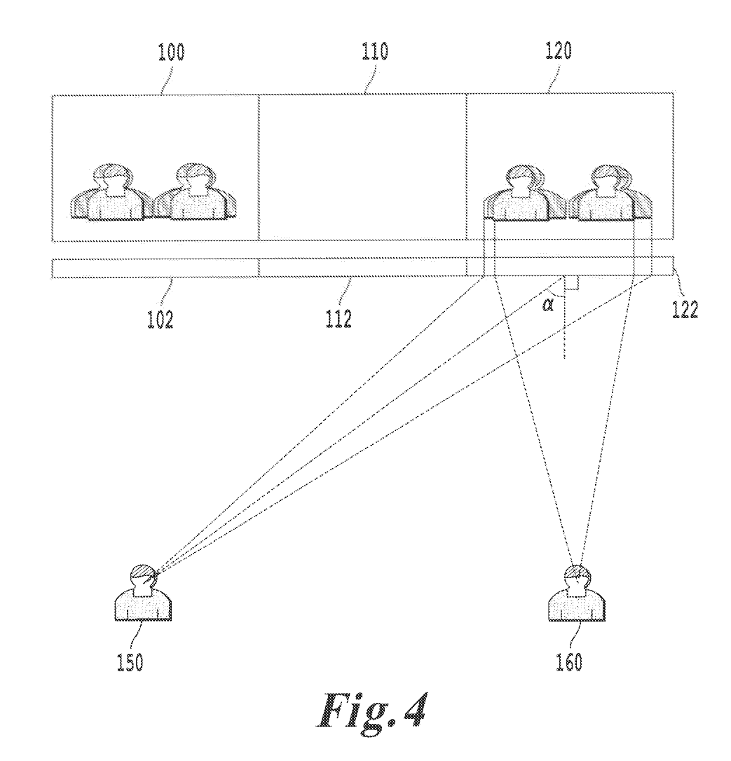

FIG. 4 is a schematic block diagram illustrating display screens used in a videoconference.

Display screens 100, 110, 120 included in or connected to a videoconferencing device, such as a videoconferencing endpoint of the telepresence type, are arranged in front of a plurality of local conference participants. The local participants are facing the display screens 100, 110, 120. For simplicity, only two conference participant 150, 160 have been illustrated.

Display screens 100, 110, 120 have been shown as front views at the top of FIG. 4. Top views of the display screens 100, 110, 120 have been shown as at 102, 112, and 122, respectively.

The display screen 120 is a multi-view display, such as an integrated multi-view display. The display screen 120 comprises two image inputs: a primary image input and a secondary image input. The image read at the primary image input is displayed in the main viewing direction of the display 120, i.e. towards the rightmost conference participant 160. The rightmost conference participant 160 has an observation angle of about 0 degrees, since he or she is placed approximately in front of the display screen 120. This is illustrated by two plain characters with normal width, shown on the display screen 120.

The image at the secondary image input of the multi-view display 120 is viewed in a direction towards the leftmost conference participant 150.

In order to obtain a more realistic and non-distorted image observed by the leftmost conference participant 150, the image at the secondary image input of the multi-view display 120 has been modified in accordance with an embodiment of the present invention, e.g. by a method as explained above with reference to FIG. 2. Hence, the image has been modified as a function of the observation angle of the leftmost participant 150 with respect to the screen 120. This means that the primary image, which is displayed in the main viewing direction of the display 120, is extended horizontally by an extension factor which is larger for higher observation angles α than for smaller observation angles α. In an exemplary case of α=60 degrees the extension factor may be in inverse proportion to cos α, i.e. extension factor=1/cos(60 degrees), resulting in extension factor=2. This means that a modified image is generated by horizontal scaling of the primary image with an extension factor of 2. This modified image is displayed on the multi-view display in the viewing direction of the leftmost conference participant 150. This is illustrated by the wider, blurred characters on the display screen 120.

In an embodiment, the image is included in a video signal originating from a remote video conference endpoint.

As a result, both local conference participants 150, 160 may view the image originating from the remote video conference in an undistorted, realistic way.

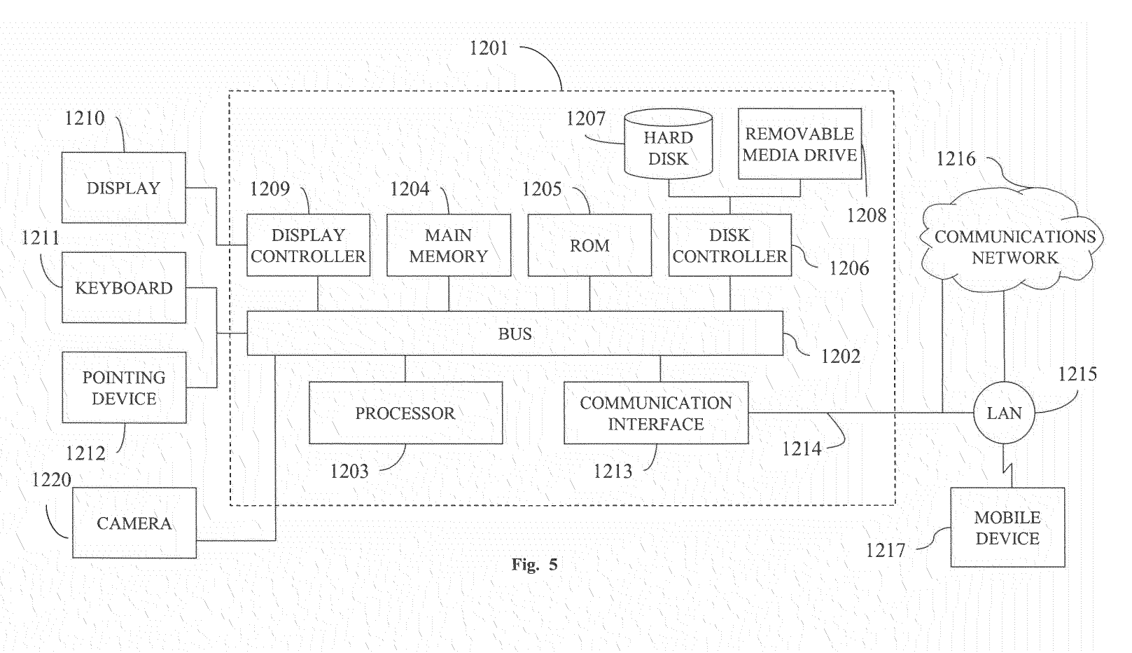

FIG. 5 illustrates a more detailed example of video conferencing device 300. The computer system 1201 includes a bus 1202 (such as bus 340 of FIG. 3) or other communication mechanism for communicating information, and a processor 1203 (such as processing device 320 of FIG. 3) coupled with the bus 1202 for processing the information. The computer system 1201 also includes a main memory 1204 (such as memory 330 of FIG. 3), such as a random access memory (RAM) or other dynamic storage device (e.g., dynamic RAM (DRAM), static RAM (SRAM), and synchronous DRAM (SDRAM)), coupled to the bus 1202 for storing information and instructions to be executed by processor 1203. In addition, the main memory 1204 may be used for storing temporary variables or other intermediate information during the execution of instructions by the processor 1203. The computer system 1201 further includes a read only memory (ROM) 1205 or other static storage device (e.g., programmable ROM (PROM), erasable PROM (EPROM), and electrically erasable PROM (EEPROM)) coupled to the bus 1202 for storing static information and instructions for the processor 1203.

The computer system 1201 also includes a disk controller 1206 coupled to the bus 1202 to control one or more storage devices for storing information and instructions, such as a magnetic hard disk 1207, and a removable media drive 1208 (e.g., floppy disk drive, read-only compact disc drive, read/write compact disc drive, compact disc jukebox, tape drive, and removable magneto-optical drive). The storage devices may be added to the computer system 1201 using an appropriate device interface (e.g., small computer system interface (SCSI), integrated device electronics (IDE), enhanced-IDE (E-IDE), direct memory access (DMA), or ultra-DMA).

The computer system 1201 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1201 may also include a display controller 1209 (such as display adapter 310 of FIG. 3) coupled to the bus 1202 to control a display 1210 (such as display 160 of FIG. 3), such as the multiview display devices discussed supra, for displaying information to a user. The computer system includes input devices, such as a keyboard 1211 and a pointing device 1212, for interacting with a computer user and providing information to the processor 1203. The pointing device 1212, for example, may be a mouse, a trackball, or a pointing stick for communicating direction information and command selections to the processor 1203 and for controlling cursor movement on the display 1210. In addition, a printer may provide printed listings of data stored and/or generated by the computer system 1201.

The computer system 1201 performs a portion or all of the processing steps of the invention in response to the processor 1203 executing one or more sequences of one or more instructions contained in a memory (which may correspond to the method show in FIG. 2), such as the main memory 1204. Such instructions may be read into the main memory 1204 from another computer readable medium, such as a hard disk 1207 or a removable media drive 1208. One or more processors in a multi-processing arrangement may also be employed to execute the sequences of instructions contained in main memory 1204.

As stated above, the computer system 1201 includes at least one computer readable storage medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes.

Stored on any one or on a combination of computer readable storage media, the present invention includes software for controlling the computer system 1201, for driving a device or devices for implementing the invention, and for enabling the computer system 1201 to interact with a human user (e.g., video conference participant). Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The computer system 1201 also includes a communication interface 1213 coupled to the bus 1202. The communication interface 1213 provides a two-way data communication coupling to a network link 1214 that is connected to, for example, a local area network (LAN) 1215, or to another communications network 1216 such as the Internet. For example, the communication interface 1213 may be a network interface card to attach to any packet switched LAN. As another example, the communication interface 1213 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1213 sends and receives electrical, electromagnetic or optical signals that carry digital data streams representing various types of information.

The network link 1214 typically provides data communication through one or more networks to other data devices. For example, the network link 1214 may provide a connection to another computer through a local network 1215 (e.g., a LAN) or through equipment operated by a service provider, which provides communication services through a communications network 1216. The local network 1214 and the communications network 1216 use, for example, electrical, electromagnetic, or optical signals that carry digital data streams, and the associated physical layer (e.g., CAT 5 cable, coaxial cable, optical fiber, etc). The signals through the various networks and the signals on the network link 1214 and through the communication interface 1213, which carry the digital data to and from the computer system 1201 maybe implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1201 can transmit and receive data, including program code, through the network(s) 1215 and 1216, the network link 1214 and the communication interface 1213. Moreover, the network link 1214 may provide a connection through a LAN 1215 to a mobile device 1217 such as a personal digital assistant (PDA) laptop computer, or cellular telephone.

Numerous modifications and variations of the present invention are possible in light of the above teachings. It is therefore to be understood that within the scope of the appended claims, the invention may be practiced otherwise than as specifically described herein.

1. A method for displaying an image on a display of a video conferencing apparatus, comprising:
providing, at the display of the video conferencing apparatus, a primary image;
providing, at the video conferencing apparatus, an observation angle of a viewer with respect to said display;
modifying, at the video conferencing apparatus, the primary image by applying a scaling factor that is a function of said observation angle to said primary image, resulting in a modified image; and
displaying said modified image on said display and said primary image on said display, wherein said modified image and said primary image are displayed in different viewing directions on a same display area of the display.

2. The method according to claim 1, wherein
said step of providing said observation angle includes providing a predetermined angle value.

3. The method according to claim 1, wherein
said step of providing said observation angle comprises determining a value of an angle between:
a direction between said viewer's position and a point of said display and a direction perpendicular to said display.

4. The method according to claim 1, wherein
said observation angle is in a horizontal plane, and
said modifying step includes horizontally scaling said primary image by applying the scaling factor.

5. The method according to claim 4, wherein
said horizontally scaling includes horizontally extending said primary image with the scaling factor which is larger for higher observation angles than for smaller observation angles.

6. The method according to claim 5, wherein
said scaling factor is substantially in inverse proportional to a cosine function of said observation angle.

7. The method according to claim 1, wherein
said display is an integrated multi-view display.

8. The method according to claim 1, wherein
said display is a multi-view projection screen illuminated by a plurality of projectors.

9. The method according to claim 1, wherein
said primary image and said modified image are included in video signals.

10. The method according to claim 1, wherein
the providing the observation angle includes using a video conference camera to obtain the observation angle of the viewer.

11. A video conferencing system, comprising:
a video conferencing endpoint configured to receive a primary image;
a processing device configured to determine an observation angle of a viewer with respect to said display,
said processing device being configured to modify the primary image by applying a scaling factor that is a function of said observation angle to said primary image, resulting in a modified image; and
display device configured to display said modified image and said primary image, wherein said modified image and said primary image are displayed in different viewing directions on a same display area of the display.

12. A computer readable storage medium encoded with instruction, which when executed by a video conference apparatus, causes the video conferencing apparatus to implement a method for displaying an image on a display, comprising
providing, at the display of the video conferencing device, a primary image;
providing, at the video conferencing device, an observation angle of a viewer with respect to said display;
modifying, at the video conferencing device, the primary image by applying a scaling factor that is a function of said observation angle to said primary image, resulting in a modified image; and
displaying said modified image on said display and said primary image on said display, wherein said modified image and said primary image are displayed in different viewing directions on a same display area of the display.

13. The computer readable storage medium according to claim 12, wherein
said step of providing said observation angle includes providing a predetermined angle value.

14. The computer readable storage medium according to claim 12, wherein
said step of providing said observation angle comprises determining a value of an angle between:
a direction between said viewer's position and a point of said display and a direction perpendicular to said display.

15. The computer readable storage medium according to claim 12, wherein
said observation angle is in a horizontal plane, and
said modifying step includes horizontally scaling said primary image by applying the scaling factor.

16. The computer readable storage medium according to claim 15, wherein
said horizontally scaling includes horizontally extending said primary image with the scaling factor which is larger for higher observation angles than for smaller observation angles.

17. The computer readable storage medium according to claim 16, wherein
said scaling factor is substantially in inverse proportional to a cosine function of said observation angle.

18. The computer readable storage medium according to claim 12, wherein
said display is an integrated multi-view display.

19. The computer readable storage medium according to claim 12, wherein
said display is a multi-view projection screen illuminated by a plurality of projectors.

20. The computer readable storage medium according to claim 12, wherein
the providing the observation angle includes using a video conference camera to obtain the observation angle of the viewer.
